(19) United States
(12) Patent Application Publication
(10) Pub. No.: US 2011/0317199 A1
(43) Pub. Date: Dec. 29, 2011

(54) PRINTER SERVER-TYPE PRINTING SYSTEM

(75) Inventors: Shinji Makishima, Shizuoka-ken (JP); Kazuhiro Ogura, Kanagawa-ken (JP); Akihiro Mizutani, Shizuoka-ken (JP); Toshihiro Ida, Shizuoka-ken (JP); Yusuke Hamada, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/169,141

(22) Filed: Jun. 27, 2011

Related U.S. Application Data
(60) Provisional application No. 61/359,186, filed on Jun. 28, 2010.

(51) Int. Cl. G06F 3/12

(52) U.S. Cl. 358/1.13

(57) ABSTRACT

According to one embodiment, a printer server-type printing system includes a printer server and a digital multifunction device. The printer server includes a first communication unit, a first control unit, and a memory. The first control unit determines whether or not an SSL is used for one or more print jobs received from an information processor through the first communication unit. When the SSL is used, the memory sets the print jobs as an SSL print jobs, and when the SSL is not used, the memory sets the print jobs as a normal print jobs. The digital multifunction device includes a second communication unit, an input unit, and a second control unit. The input unit receives an input of one or more a target print jobs. The second control unit requests the target print jobs input in the input unit to the printer server through the second communication unit.

### CROSS-REFERENCE TO RELATED APPLICATIONS

This application is based upon and claims the benefit of priority from Provisional Application No. 61/359,186, filed on Jun. 28, 2010; the entire contents of which are incorporated herein by reference.

### FIELD

Embodiments described herein relate generally to a printer server-type printing system.

### BACKGROUND

Conventionally, a printer server-type printing system is widely used. In such a system, a print job for a document prepared by a client PC is temporarily saved in a printer server, and the print job can be selectively output when a user performs personal authentication with an arbitrary MFP (Multi Function Peripheral). From the viewpoint of maintaining confidentiality, the user can also transmit the print job to the printer server from the client PC through encryption communication. Accordingly, this type of printer server saves a combination of a print job transmitted through the encryption communication and a print job transmitted through normal communication.

When a print job transmitted through the encryption communication is printed by an arbitrary MFP, the printer server and the MFP also need to appropriately communicate with each other.

### BRIEF DESCRIPTION OF THE DRAWINGS

FIG. 1 is a block diagram illustrating a printer server-type printing system of a first embodiment.

FIG. 2 is a view illustrating an information communication performed in the printer server-type printing system.

FIG. 3 is a view of a screen of a client PC.

FIG. 4 is a view illustrating a table that the printer server saves.

FIG. 5 is a flowchart illustrating a process in the printer server.

FIG. 6 is a flowchart illustrating a process in the printer server.

FIG. 7 is a view of a screen in the MFP.

FIG. 8 is a flowchart illustrating a process in the printer server.

FIG. 9 is a flowchart illustrating a process in the printer server of a second embodiment.

FIG. 10 is a view illustrating a table that a printer server of a third embodiment saves.

FIG. 11 is a flowchart illustrating a process in the printer server.

FIG. 12 is a view illustrating a table that a printer server of a fourth embodiment saves.

FIG. 13 is a flowchart illustrating a process in the printer server.

FIG. 14 is a flowchart illustrating a process in the printer server of a fifth embodiment.

FIG. 15 is a view of a screen in the MFP.

### DETAILED DESCRIPTION

In general, according to one embodiment, a printer server-type printing system includes a printer server and a digital multifunction device. The printer server includes a first communication unit, a first control unit, and a memory. The first control unit determines whether or not an SSL is used for one or more print jobs received from an information processor through the first communication unit. When the SSL is used, the memory sets the print jobs as an SSL print jobs, and when the SSL is not used, the memory sets the print jobs as a normal print jobs. The digital multifunction device includes a second communication unit, an input unit, and a second control unit. The input unit receives an input of one or more a target print jobs. The second control unit requests the target print jobs input in the input unit to the printer server through the second communication unit.

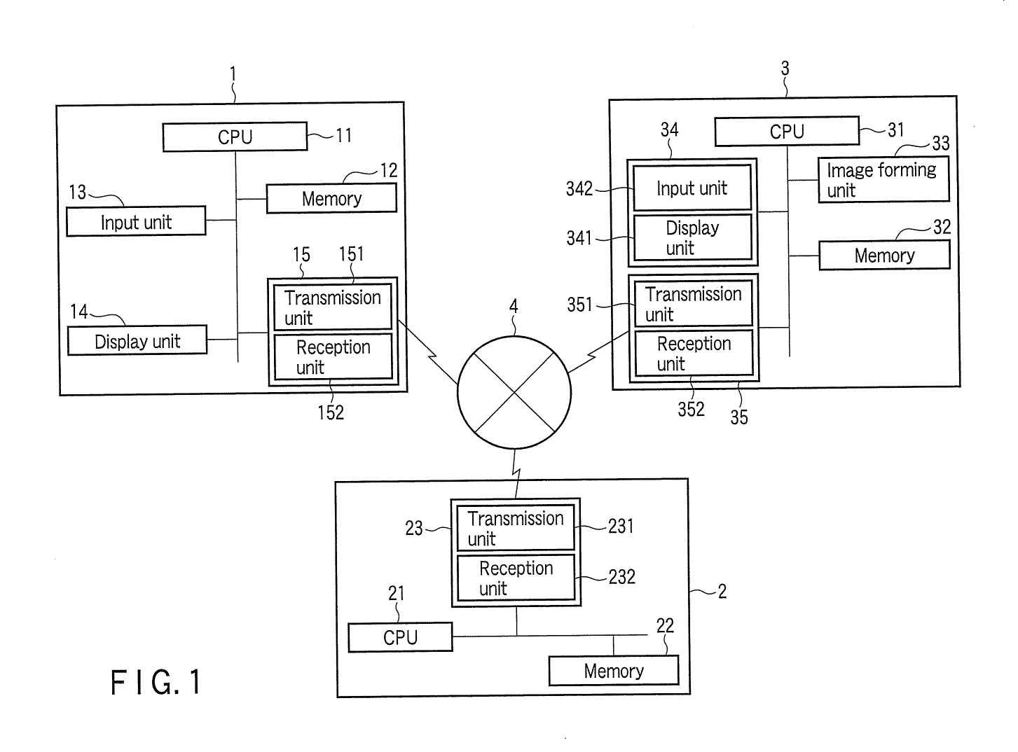

Hereinafter, a first embodiment will be described with reference to the drawings. FIG. 1 is a block diagram illustrating a printer server-type printing system of the first embodiment. The printer server-type printing system includes a client PC (information processor) 1, a printer server 2, and an MFP (digital multifunction device) 3. The client PC 1 is registered in the printer server 2 and includes a function of transmitting a print job to the printer server 2. The printer server 2 includes a function of temporarily saving (registering) the print job for each user. The MFP 3 includes a function of selectively printing the print job saved in the printer server 2. These devices are connected to each other through a network 4 configured with a LAN or the like so as to be able to mutually exchange information through two-way communication in the system. Although FIG. 1 illustrates only a single client PC and a single MFP, the number of client PCs and MFPs included in the system is not limited.

The client PC 1 includes a CPU 11, a memory 12, an input unit 13, a display unit 14, and a communication unit 15. The CPU 11 controls the operation of each unit of the client PC 1. The memory 12 saves programs and various types of information. The input unit 13 receives various types of inputs created by a user. The display unit 14 displays various types of information. The communication unit 15 connects the client PC 1 to the network 4. The communication unit 15 includes a transmission unit 151 and a reception unit 152. The transmission unit 151 transmits information to other devices in the system through the network 4. For example, the transmission unit 151 transmits the print job of the document prepared by the client PC 1 to the printer server 2. The reception unit 152 transmits information to other devices in the system through the network 4.

The printer server 2 includes a CPU (control unit) 21, a memory 22, and a communication unit 23. The CPU 21 controls the operation of each unit of the printer server 2. The memory 22 saves programs and various types of information. For example, the memory 22 saves the print job by associating the print job with each user (user ID). The communication unit 23 connects the printer server 2 to the network 4. The communication unit 23 includes a transmission unit 231 and a reception unit 232. The transmission unit 231 transmits information to other devices in the system through the network 4. For example, the transmission unit 231 transmits the print job saved in the memory to the MFP 3. The reception unit 232 receives information from other devices in the system through the network 4. For example, the reception unit 232 receives the print job from the client PC 1.

The MFP 3 includes a CPU (control unit) 31, a memory 32, an image forming unit 33, a control panel 34, and a communication unit 35. The CPU 31 controls the operation of each unit in the MFP 3. The memory 32 saves programs and various types of information. The image forming unit 33 outputs by printing the image information on paper based on the print job. The control panel 34 integrally includes a display unit 341 and an input unit 342. The display unit 341 is a liquid crystal monitor displaying various types of information. The input unit 342 is a touch panel in which necessary information can be input. The communication unit 35 connects the MFP 3 to the network 4. The communication unit 35 includes a transmission unit 351 and a reception unit 352. The transmission unit 351 transmits information to other devices in the system through the network 4. For example, the transmission unit 351 transmits a request for the target print job input in the input unit 342 to the printer server 2. The reception unit 352 receives information from other devices in the system through the network 4. For example, the reception unit 352 receives the target print job from the printer server 2.

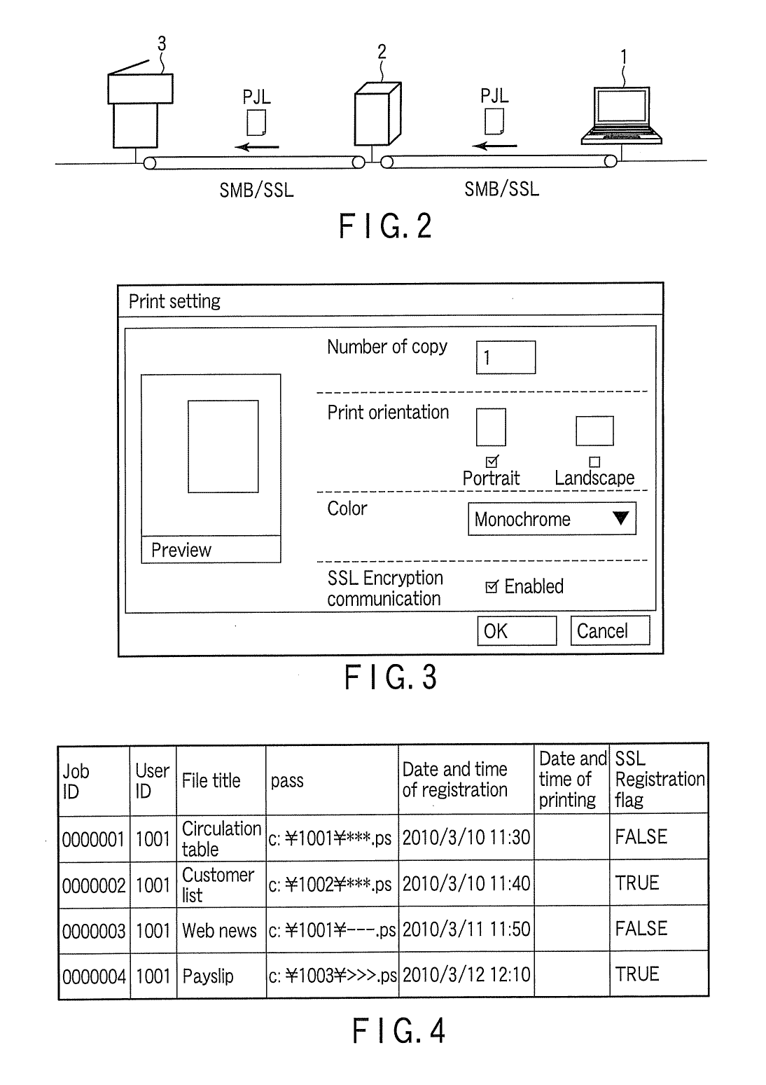

Next, the information communication performed in the printer server-type printing system of the first embodiment will be described with reference to FIG. 2. First, an example in which the client PC 1 transmits the print job to the printer server 2 will be described. In this case, the printer server 2 functions as an SSL printer server, and the client PC 1 functions as an SSL client. When the client PC 1 transmits the print job to the printer server 2 without performing SSL (Secure Socket Layer) encryption communication, the client PC 1 uses a normal SMB (Server Message Block) protocol, thereby transmitting the print job to the printer server 2 in a PJL (Printer Job Language).

When the client PC 1 transmits the print job to the printer server 2 by performing the SSL (Secure Socket Layer) encryption communication, a session of the SSL encryption communication is established in the following manner. Herein, a method of public key encryption will be described. First, the client PC 1 gains access to the printer server 2. The printer server 2 transmits a printer server certificate including a public key to the client PC 1. The client PC 1 creates a common key and transmits the common key (encryption key) encrypted with the public key to the printer server 2. The printer server 2 obtains the common key by decrypting the received encryption key with a secret key. Subsequently, by using the common key, the printer server 2 and the client PC 1 executes the encryption communication by using the SMB and SSL protocols. By using the SMB and SSL protocols, the client PC 1 transmits the print job to the printer server 2 in the PJL. Herein, an example was described in which the client PC 1 transmits the print job to the printer server 2; however, even when the printer server 2 transmits the print job to the MFP 3, the same configuration is applied. In this case, the MFP 3 functions as the SSL printer server, and the printer server 2 functions as the SSL client.

Next, the print setting in the client PC 1 will be described. FIG. 3 is a view of the print setting screen in the client PC 1. When a user makes a predetermined input in the input unit 13 to transmit the print job to the printer server 2, the CPU 11 drives a printer driver saved in the memory 12. The CPU 11 controls the display unit 14 to display the print setting screen created by the printer driver as shown in FIG. 3. In the print setting screen, in addition to the settings of the number of copies of a document, the print orientation, and color or monochromic printing, enabling or disabling the SSL encryption communication can be set, as the print job. When the user sets the SSL encryption communication to be disabled, the CPU 11 converts the print job into the PJL by using the printer driver. Thereafter, as described above, the CPU 11 controls the transmission unit 151 to transmit the print job to the printer server 2 in the PJL by using the normal SMB protocol. On the other hand, when the user sets the SSL encryption communication to be enabled, the CPU 11 converts the print job into the PJL by using the printer driver. Subsequently, as described above, the CPU 11 controls the transmission unit 151 to transmit the print job to the printer server 2 in the PJL by using the SMB and SSL protocols. When the user sets the SSL encryption communication to be enabled, the CPU 11 may embed an SSL-enabling parameter in the PJL of the print job by using the printer driver.

Next, a job management table that the printer server 2 saves will be described. FIG. 4 is a view illustrating a job management table based on the print job transmitted from the client PC 1. After receiving the print job from the client PC 1 through the reception unit 232, the CPU 21 newly registers the print job in the job management table. That is, whenever the print job is received, the CPU 21 updates the job management table. The job management table is saved in the memory 22. In the first embodiment, the print job registered in the job management table is called a registered print job.

In the job management table, as shown in FIG. 4, a job ID, a user ID, a file title, a pass, the date and time of registration, the date and time of printing, and an SSL registration flag are registered for each registered print job. The SSL registration flag shows whether the SSL encryption communication is set to be enabled or disabled on the print setting screen shown in FIG. 3. If the SSL registration flag is set to be TRUE, this shows that the SSL encryption communication is set to be enabled. In the first embodiment, the registered print job for which the SSL registration flag is set to be TRUE is called a registered SSL print job. If the SSL registration flag is set to be FALSE, this shows that the SSL encryption communication is set to be disabled. In the first embodiment, the registered print job for which the SSL registration flag is set to be FALSE is called a registered normal print job. That is, when the SSL encryption communication is used, the memory 22 registers the print job as the registered SSL print job, and when the SSL encryption communication is not used, the memory 22 registers the print job as the registered normal print job.

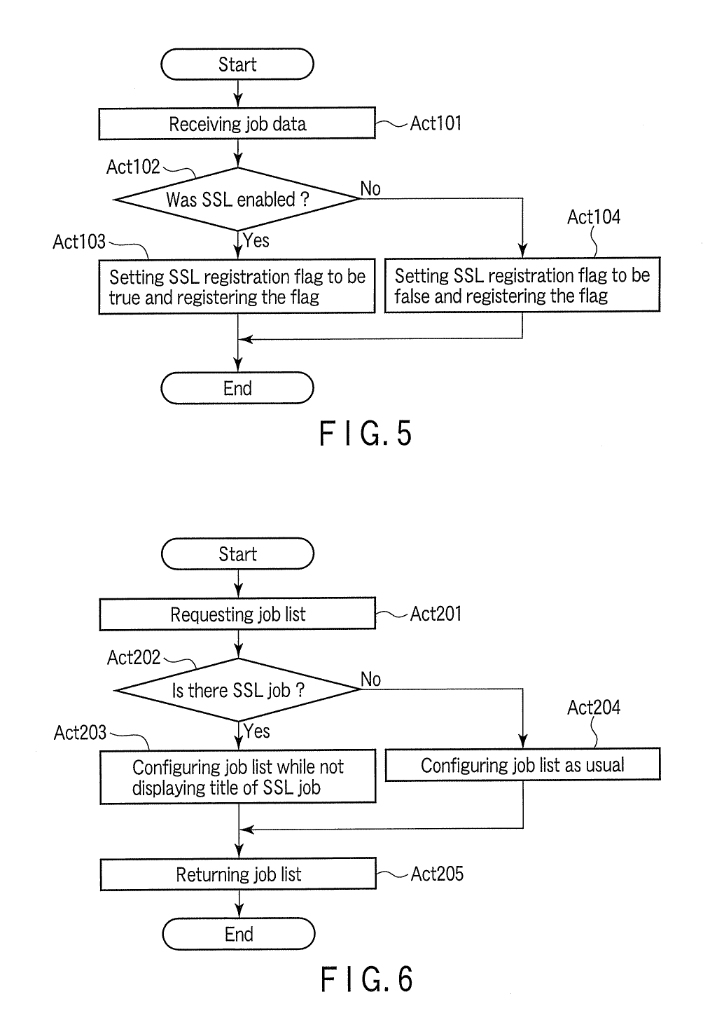

Next, the registration of the print job in the job management table performed in the printer server 2 will be described. FIG. 5 is a flowchart illustrating the registration of the print job. First, the CPU 21 receives the print job from the client PC 1 through the reception unit 232 (Act 101). Regarding the received print job, the CPU 21 determines whether or not the SSL encryption communication is set to be enabled (Act 102). That is, in Act 101, the CPU 21 determines whether or not the SSL encryption communication is used to transmit the print job to the printer server 2 from the client PC 1. For example, the CPU 21 determines whether the SSL encryption communication is set to be enabled, with reference to the SSL-enabling parameters embedded in the PJL of the print job.

When the SSL encryption communication is set to be enabled (ACT 102, Yes), regarding the received print job, the CPU 21 sets the SSL registration flag in the job management table to be TRUE and registers the flag (Act 103). When the SSL encryption communication is not set to be enabled (in other words, is set to be disabled), (Act 102, No), regarding the received print job, the CPU 21 sets the SSL registration flag in the job management table to be FALSE and registers the flag (Act 104).

Next, a process will be described in which the printer server transmits a list of the registered print jobs to the MFP 3 when the user inputs an output request for the registered print job. The list of registered print jobs is created by extracting at least the date and time of registration and the file title from the job management table shown in FIG. 4, with respect to each of the registered print job. For example, when the user inputs a password specifying the user ID in the input unit 342 of the MFP 3, the CPU 31 transmits a request for the list of registered print jobs corresponding to the input user ID to the printer server 2, after the user authentication. FIG. 6 is a flowchart illustrating the transmission of the list of registered print jobs from the printer server 2 to the MFP 3.

The CPU 21 receives the request for the list of registered print jobs from the MFP 3 (Act 201). In Act 201, the CPU 21 extracts the target registered print job from the job management table and creates the list of registered print jobs. The CPU 21 determines whether or not the registered SSL print job is included in the list of registered print jobs (Act 202). When the registered SSL print job is included (Act 203, Yes), the CPU 21 configures the list of registered print jobs while not displaying the title of the registered SSL print jobs (Act 204). When the registered SSL print job is not included (Act 203, No), the CPU 21 configures the list of registered print jobs while displaying the title of the registered SSL print job as usual (Act 204). Thereafter, the CPU 21 transmits the list of registered print jobs to the MFP 3 through the transmission unit 231 (Act 205). That is, based on the user ID and the request for the list of registered print jobs which are input in the input unit 342, the CPU 21 transmits the list of registered print jobs in which the file name of the registered SSL print job is not displayed to the MFP 3, according to the user ID.

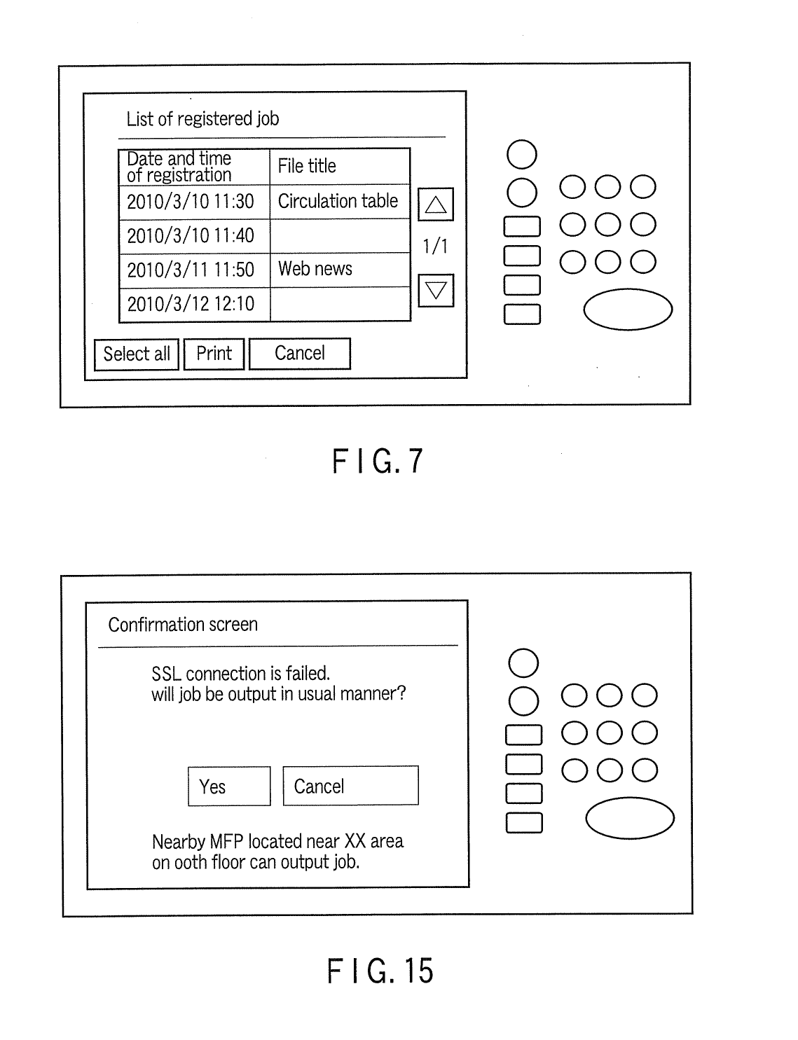

In the MFP 3, the CPU 31 receives the list of registered print jobs through the reception unit 352, and controls the display unit 341 to display the screen of the list of registered print jobs. FIG. 7 is a view illustrating an example of a screen of the list of registered print jobs, which is displayed on the display unit 341. On the screen of the list of registered print jobs, the title of the registered SSL print job is not displayed. Accordingly, the user can easily tell which registered print job is a registered SSL print job. On the screen of the list of registered print jobs, the title of the registered SSL print job may not be displayed, and in addition to this, a message indicating the SSL print job may be displayed. The user can select an arbitrary target registered print job on the screen of the list of registered print jobs and press a print button. The input unit 13 receives the input of one or more of the target registered print jobs which are selected. Thereafter, the CPU 31 transmits a request for the target registered print job to the printer server 2 through the transmission unit 351.

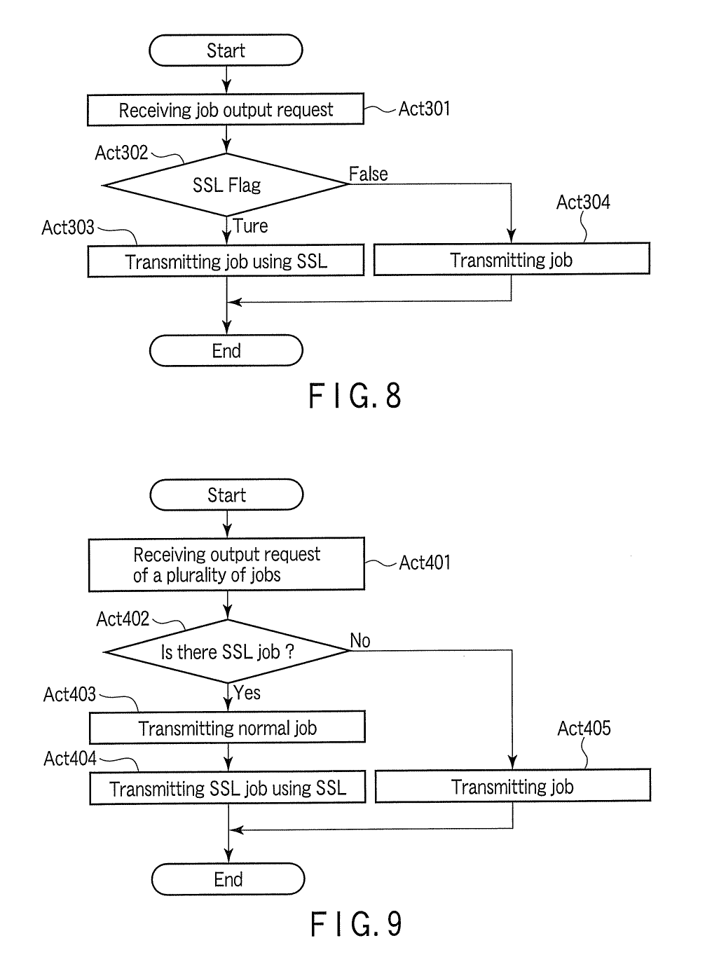

Next, a process will be described in which the printer server 2 transmits the registered print job to the MFP 3 when the user selects a single target registered print job on the screen of the list of registered print jobs. FIG. 8 is a flowchart illustrating the transmission of the target registered print job from the printer server 2 to the MFP 3. First, the CPU 21 receives a request for the target registered print job from the MFP 3 through the reception unit 232 (Act 301). Regarding the target registered print job, the CPU 21 obtains the state of the SSL registration flag, with reference to the job management table (Act 302). When the SSL registration flag is registered to be TRUE (Act 302, TRUE), the CPU 21 transmits the target registered print job to the MFP 3 through the transmission unit 231 by using the SSL encryption communication (Act 303). The session of the SSL encryption communication between the printer server 2 and the MFP 3 is established in the above-described manner. When the SSL registration flag is registered to be FALSE (Act 302, FALSE), the CPU 21 transmits the target registered print job to the MFP 3 through the transmission unit 231 without using the SSL encryption communication (Act 304).

Next, the second embodiment will be described. The second embodiment relates to a process in which the printer server 2 transmits the target registered print job to the MFP 3 when the user selects a plurality of target registered print jobs on the screen of the list of registered print jobs. FIG. 8 is a flowchart illustrating the transmission of the target registered print job to the MFP 3.

First, the CPU 21 receives a request for a plurality of target registered print jobs from the MFP 3 through the reception unit 232 (Act 401). The CPU 21 determines whether or not at least one registered SSL print job is included in the target registered print jobs, with reference to the job management table (Act 402). When the registered SSL print job is included (Act 402, Yes), through the transmission unit 231, the CPU 21 transmits the registered normal print job among the target registered print jobs to the MFP 3 without using the SSL encryption communication (Act 403). Subsequently, through the transmission unit 231, the CPU 21 transmits the registered SSL print job among the target registered print jobs to the MFP 3 by using the SSL encryption communication (Act 403). That is, when the target registered print job includes a combination of the registered SSL print job and the registered normal print job, the CPU 21 transmits the registered normal print job to the MFP 3 before the registered SSL print job. When the registered SSL print job is not included (Act 402, NO), through the transmission unit 231, the CPU 21 transmits the target registered print job (in which the entire job is registered normal print job) to the MFP 3 without using the SSL encryption communication (Act 404).

According to the second embodiment, the delay of the first printing caused by the time taken for establishing the session of the SSL encryption communication between the printer server 2 and the MFP 3 and for encrypting the registered SSL print job is resolved. Consequently, even when the user selects a plurality of target registered print jobs for one output request, it is possible to consider so that the user does not notice the waiting time.

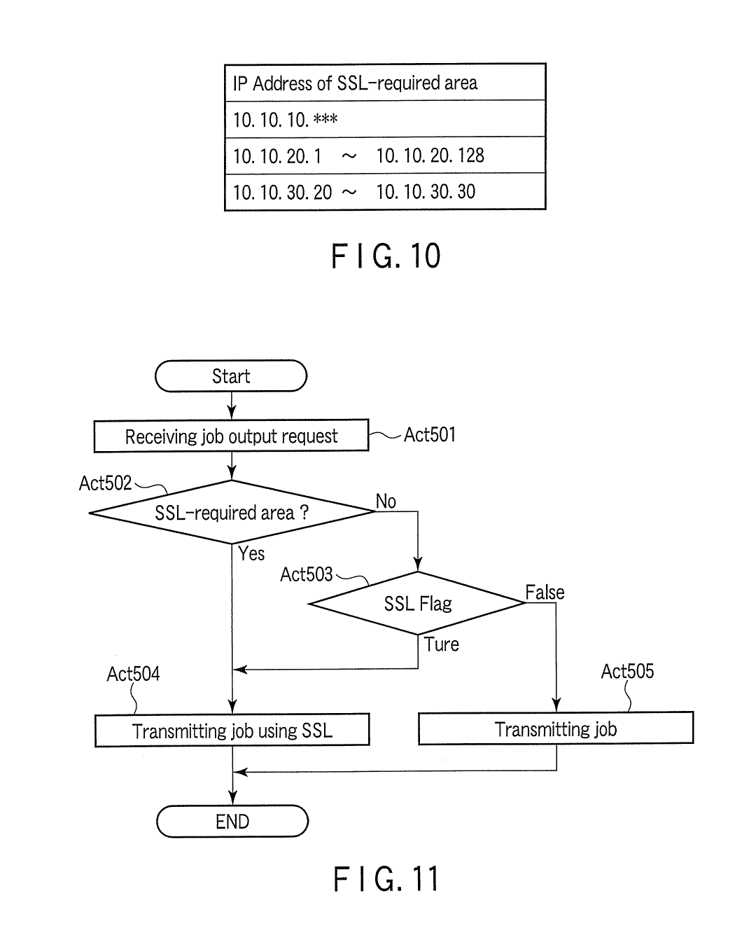

Next, the third embodiment will be described. In the third embodiment, the memory 22 of the printer server 2 saves an IP address management table shown in FIG. 10. The IP address management table manages the IP address of the MFP 3 which is installed in an area with a high level of security policy (hereinafter, referred to as an SSL encryption communication-required area) where the SSL encryption communication between the printer server 2 and the MFP 3 is required. The third embodiment relates to a process in which the printer server 2 determines whether or not the MFP 3 transmitting the request for the target registered print job is in the SSL encryption communication-required area.

FIG. 11 is a flowchart illustrating the transmission of the target registered print job from the printer server 2 to the MFP 3. First, the CPU 21 receives a request for the target registered print job from the MFP 3 through the reception unit 232 (Act 501). The CPU 21 determines whether or not the MFP 3 transmitting the request for the target registered print job is in the encryption communication-required area (Act 502). That is, in Act 502, the CPU 21 determines whether or not the IP address of the MFP 3 transmitting the request for the target registered print job is included in the IP address management table. When the MFP 3 is not in the encryption communication-required area (Act 502, No), regarding the target registered print job, the CPU 21 obtains the state of the SSL registration flag with reference to the job management table (Act 503). When the SSL registration flag is registered to be TRUE (Act 503, TRUE), through the transmission unit 231, the CPU 21 transmits the target registered print job to the MFP 3 by using the SSL encryption communication (Act 504). When the SSL registration flag is registered to be FALSE (Act 503, FALSE), through the transmission unit 231, the CPU 21 transmits the target registered print job to the MFP 3 without using the SSL encryption communication (Act 505). When the MFP 3 is in the encryption communication-required area (Act 502, Yes), in Act 504, the CPU 21 transmits the target registered print job to the MFP 3 by using the SSL encryption communication through the transmission unit 231, regardless of the state of the SSL registration flag.

According to the third embodiment, when the target registered print job is output to the MFP 3 which is installed in the area with a high level of security policy from the printer server 2, the entire target registered print job is transmitted by using the SSL encryption communication. Accordingly, the target registered print job is kept confidential.

The third embodiment can also be applied even when the client PC 1 is installed in the encryption communication-required area. For example, even when the client PC 1 registers the print job in the printer server 2, if the client PC 1 is determined to be in the encryption communication-required area with reference to the IP address, the printer server 2 may forcedly receive the print job by using the SSL encryption communication, regardless of the setting in the client PC 1 in which the SSL encryption communication is enabled or disabled.

Next, the fourth embodiment will be described. The fourth embodiment relates to a process in which a client certificate is obtained when the printer server 2 transmits the registered SSL print job to the MFP 3.

In the session of the SSL encryption communication between the MFP 3 (which functions as an SSL printer server herein) and the printer server 2 (which functions as an SSL client herein), a client certificate needs to be installed in the printer server 2 for the mutual SSL authentication between the MFP 3 and the printer server 2. Accordingly, the MFP 3 needs to issue a client certificate to the printer server 2. A sheet of the client certificate can be purchased from a commercially available public certificate authority so as to be installed in the printer server 2. Moreover, in order to reduce the cost, the client certificate can be issued from a private certificate authority which is included in the MFP 3 as a function and then installed in the printer server 2. If the latter is the case, since the printer server-type printing system according to the fourth embodiment is a system of one (printer server 2) against many (MFP), it is possible to use a method in which each MFP issues a sheet of client certificate. Furthermore, the printer server-type printing system according to the fourth embodiment can also use a method in which a single MFP issues a sheet of the client certificate, and the client certificate is installed in another MFP. In the fourth embodiment, the former method will be described in which each MFP issues a sheet of client certificate.

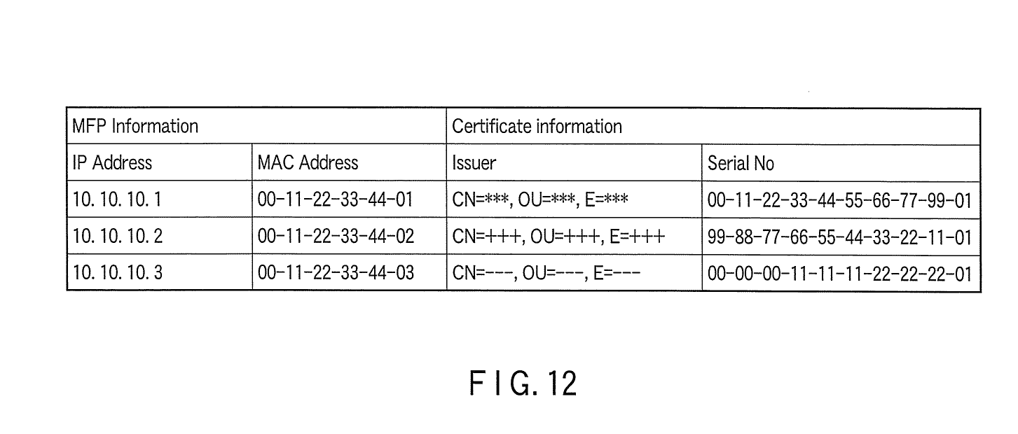

FIG. 12 is a view illustrating a certificate management table that the printer server 2 saves. The certificate management table manages the client certificate which is issued for each MFP and installed in the memory 22. In the certificate management table, an IP address and a MAC address as the information specifying each MFP are recorded as well as the issuer of the client certificate and the serial number as the information specifying the client certificate.

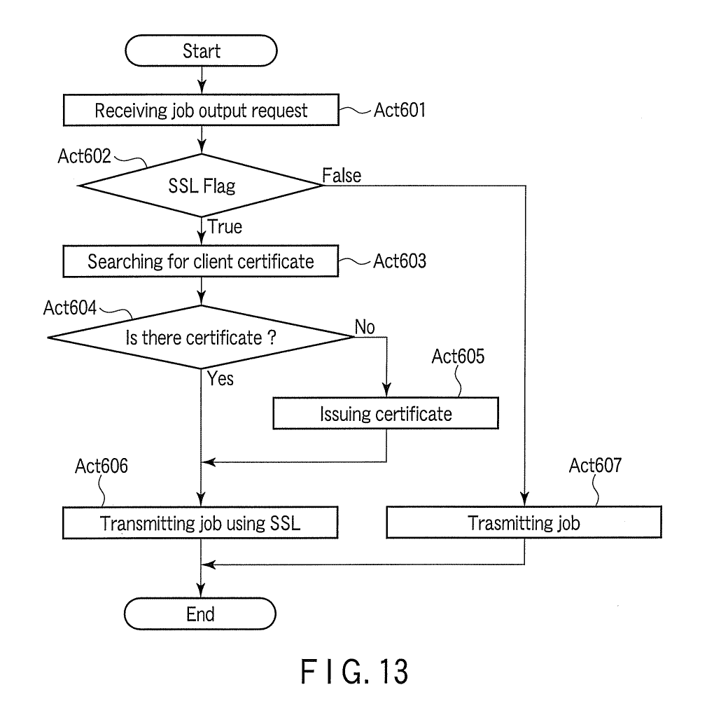

FIG. 13 is a flowchart illustrating the transmission of the target registered print job to the MFP 3 from the printer server 2. First, the CPU 21 receives a request for the target registered print job from the MFP 3 through the reception unit 232 (Act 601). Regarding the target registered print job, the CPU 21 obtains the state of the SSL registration flag with reference to the job management table (Act 602). When the SSL registration flag is registered to be TRUE (Act 302, TRUE), the CPU 21 searches for the client certificate for MFP 3 transmitting the request for the target registered print job, with reference to the certificate management table shown in FIG. 12 (Act 603). In Act 603, the CPU 21 obtains, for example, the IP address or the MAC address of the MFP 3 transmitting the request for the target registered print job, and compares the address to the certificate management table, thereby searching for the client certificate corresponding to the MFP 3 transmitting the request for the target registered print job in the certificate management table.

When there is no client certificate corresponding to the MFP 3 transmitting the request for the target registered print job in the certificate management table (Act 604, No), the CPU 21 asks for the MFP 3 transmitting the request for the target registered print job to issue the client certificate (Act 605). That is, when the target registered print job is the registered SSL print job, and the client certificate for mutual SSL authentication between the printer server 2 and the MFP 3 is not installed in the memory 22, the CPU 21 obtains the client certificate from the MFP 3. The case where the client certificate corresponding to the MFP transmitting the request for the target registered print job is not in the certificate management table corresponds to, for example, a case where the printer server 2 receives for the first time a request for the registered SSL print job as the target registered print job from the MFP 3. In Act 605, through the reception unit 232, the CPU 21 receives a specific client certificate from the MFP 3 transmitting the request for the target registered print job, and then installs the client certificate in a memory 32. As a method of issuing the certificate, the MFP 3 executes an online issuing function such as a SCEP (Simple Certificate Enrollment Protocol). Subsequently, the CPU 21 performs the mutual authentication with the MFP 3 by using the specific client certificate, and transmits the target registered print job to the MFP 3 by using the SSL encryption communication through the transmission unit 231 (Act 606).

When there is the client certificate corresponding to the MFP transmitting the request for the target registered print job in the certificate management table (Act 604, Yes), the CPU 21 executes the operation of Act 606. When the SSL registration flag is registered to be FALSE (Act 602, FALSE), through the transmission unit 231, the CPU 21 transmits the target registered print job to the MFP 3 without using the SSL encryption communication (Act 607).

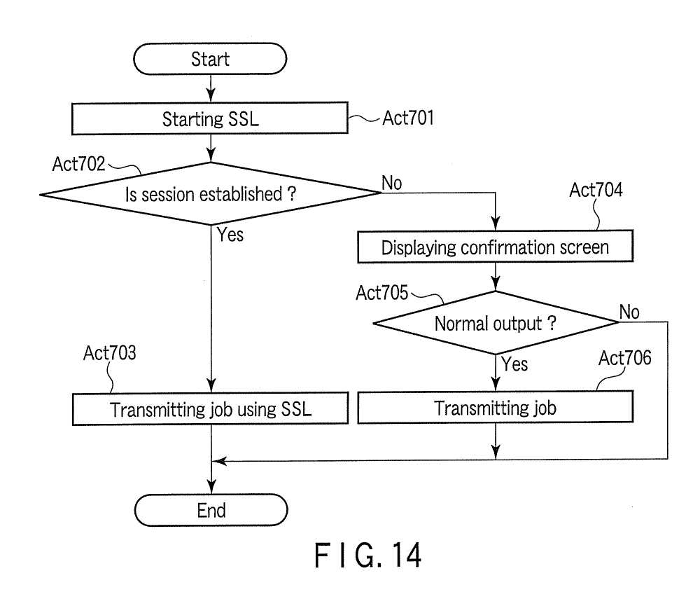

Next, the fifth embodiment will be described. The fifth embodiment relates to a process in which the information of a confirmation screen to be displayed on the display unit 341 of the MFP 3 is transmitted to the MFP 3, when the printer server 2 fails to establish the session of the SSL encryption communication performed with the MFP 3. FIG. 14 is a flowchart illustrating the transmission of the target registered print job to the MFP 3 from the printer server 2. In the fifth embodiment, the printer server 2 receives the request for the registered SSL print job as the target registered print job from the MFP 3. First, the CPU 21 of the printer server 2 starts establishing the session of the SSL encryption communication performed with the MFP 3 (Act 701). The CPU 21 determines whether or not the establishment of the session of the SSL encryption communication has succeeded (Act 702). Examples of factors which cause failure in the establishment of the session of the SSL encryption communication include absence of the SSL function in the MFP 3, expiration or revocation of the printer server certificate, discrepancy between the common name of the printer server certificate and the IP address, failure in the client authentication and the like.

When the establishment of the session of the SSL encryption communication is succeeded (Act 702, Yes), through the transmission unit 231, the CPU 21 transmits the target registered print job to the MFP 3 by using the SSL encryption communication (Act 703). When the establishment of the session of the SSL encryption communication fails (Act 702, No), the CPU 21 transmits the screen information to the MFP 3 so as to display the confirmation screen shown in FIG. 15 on the MFP 3 (Act 704). The CPU 31 of the MFP 3 controls the display unit 341 to display the confirmation screen. The confirmation screen shown in FIG. 15 displays a message which informs of the failure in the establishment of the session of the SSL encryption communication. In addition, the confirmation screen performs display so that the user can select whether or not the registered SSL print job will be transmitted without using the SSL encryption communication. Moreover, the confirmation screen displays a message which informs about a place where the MFP 3 that can perform the SSL encryption communication is installed. Through the transmission unit 351, the CPU 31 transmits selection information on whether the output by the registered normal print job is selected or cancelled on the confirmation screen to the printer server 2.

Based on the selection information received from the MFP 3, the CPU 21 determines whether or not the user has selected the output by the registered normal print job (Act 705). When it is determined that the output by the registered normal print job is selected (Act 705, Yes), through the transmission unit 231, the CPU 21 transmits the target registered print job to the MFP 3 without using the SSL encryption communication (Act 703). When it is determined that the output by the registered normal print job is not selected (Act 705, No), the CPU 21 ends the process without transmitting the target registered print job to the MFP 3.

In Act 704, if a problem can be resolved by reissuing the printer server certificate, the CPU 21 may transmit the screen information on the solution to the MFP 3. When the MFP 3 is installed in the encryption communication-required area as described above in the fourth embodiment, the CPU 21 may forcibly cancel the process of transmitting the registered print job, and display a message which informs of a place where the MFP 3 that can perform the SSL encryption communication is installed on the confirmation screen, without performing display to make the user select whether or not the registered SSL print job will be transmitted without using the SSL encryption communication.

According to the first to fifth embodiments, the transmission of the registered print job registered in the memory of the printer server 2 to the MFP 3 is managed adaptively. Therefore, the registered print job is kept confidential.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer server-type printing system comprising:
a printer server which includes a first communication unit, a first control unit which determines whether or not one or more print jobs received from an information processor through the first communication unit use an SSL, and a memory which sets the print jobs as SSL print jobs when the SSL is used and sets the print jobs as normal print jobs when the SSL is not used; and
a digital multifunction device which includes a second communication unit, an input unit which receives an input of one or more target print jobs, and a second control unit which transmits a request for the target print jobs input in the input unit to the printer server through the second communication unit.

2. The system of claim 1,
wherein when the target print jobs are the SSL print jobs, the first control unit transmits the target print jobs to the digital multifunction device by using the SSL.

3. The system of claim 2,
wherein when the target print jobs are the normal print jobs, the first control unit transmits the target print jobs to the digital multifunction device without using the SSL.

4. The system of claim 3,
wherein when the target print jobs include the SSL print jobs and the normal print jobs, the first control unit transmits the normal print jobs to the digital multifunction device before the SSL print jobs.

5. The system of claim 1,
wherein based on a user ID and a request for a list of the print jobs which are input in the input unit, the first control unit transmits the list of the print jobs in which a file name of the SSL print jobs are not displayed to the digital multifunction device, according to the user ID.

6. The system of claim 5,
wherein the digital multifunction device includes a display unit displaying the list of the print jobs.

7. The system of claim 1,
wherein when the digital multifunction device is installed in an area with a high level of security policy, the first control unit transmits the target print jobs to the digital multifunction device by using the SSL.

8. The system of claim 7,
wherein based on an IP address, the first control unit determines whether or not the digital multifunction device is installed in the area with a high level of security policy.

9. The system of claim 2,
wherein when the target print jobs are the SSL print jobs, and a certificate for mutual SSL authentication between the printer server and the digital multifunction device is not installed in the memory, the first control unit obtains the certificate from the digital multifunction device.

10. The system of claim 2,
wherein, when the target print jobs are the SSL print jobs, and a session of the SSL fails to be established between the first control unit and the digital multifunction device, the first control unit transmits display screen information asking whether or not the SSL print jobs will be transmitted without using the SSL to the digital multifunction device.

11. A method of managing a print jobs comprising:
causing a printer server to determine whether or not one or more print jobs received from an information processor use an SSL, to set the print jobs as SSL print jobs when the SSL is used, and to set the print jobs as normal print jobs when the SSL is not used; and
causing a digital multifunction device to receive an input of one or more target print jobs, and to transmit a request for the target print jobs to the printer server.

12. The method of claim 11 comprising:
transmitting the target print jobs to the digital multifunction device from the printer server by using the SSL when the target print jobs are the SSL print jobs.

13. The method of claim 12 comprising:
transmitting the target print jobs to the digital multifunction device from the printer server without using the SSL when the target print jobs are the normal print jobs.

14. The method of claim 13 comprising:
transmitting the normal print jobs to the digital multifunction device from the printer server before the SSL print jobs when the target print jobs include the SSL print jobs and the normal print jobs.

15. The method of claim 11 comprising:
transmitting a list of the print jobs in which a file name of the SSL print jobs are not displayed to the digital multifunction device from the printer server according to a user ID, based on the user ID and a request for the list of the print jobs which are input in the printer server.

16. The method of claim 15 comprising:
displaying the list of the print jobs on the digital multifunction device.

17. The method of claim 11 comprising:
transmitting the target print jobs to the digital multifunction device from the printer server by using the SSL when the digital multifunction device is installed in an area with a high level of security policy.

18. The method of claim 17 comprising:
determining by the printer server whether or not the digital multifunction device is installed in the area with a high level of security policy, based on an IP address.

19. The method of claim 12 comprising:
transmitting a certificate to the printer server from the digital multifunction device, when the target print jobs are the SSL print jobs, and the certificate for mutual SSL authentication between the printer server and the digital multifunction device is not installed in the memory.

20. The method of claim 12 comprising:
transmitting display screen information asking whether or not the SSL print jobs will be transmitted without using the SSL to the digital multifunction device from the printer server, when the target print jobs are the SSL print jobs, and a session of the SSL failed to be established between the digital multifunction device and the printer server.
